(19) United States
(12) Patent Application Publication
(10) Pub. No.: US 2007/0137430 A1
(43) Pub. Date: Jun. 21, 2007

(54) Pedal structure without front clamping members

(76) Inventors: Kuo-Chih Chao, Taichung City (TW); Chia-Pin Chen, Taichung City (TW)

Correspondence Address: KUO-CHIH CHAO, P.O. Box 44 - 2049, Taipei, 10668, TW

(21) Appl. No.: 11/255,944

(22) Filed: Oct. 24, 2005

(51) Int. Cl. G05G 1/14

(52) U.S. Cl. 74/594.6

(57) ABSTRACT

This invention relates to a pedal structure without front clamping members set thereon, in particular, a pedal structure enabling a rider's foot/leg joints to horizontally swivel as appropriate or move up and downs at certain narrow angels, so that a rider to flexibly move leg/foot joints, reduce tiredness on legs and enjoy more comfortable feeling during his/her bicycle riding.

### BACKGROUND OF THE INVENTION

1) Field of the Invention

This invention relates to a pedal structure without front clamping members set thereon, in particular, a pedal structure that enables a rider to flexibly move leg/foot joints, reduce tiredness on legs and enjoy more comfortable feeling during bicycle riding.

2) Description of the prior art

Generally, cleat members are set on a pair of racing bicycle shoe soles for being coupled to a pair of bicycle pedals, so as to integrate a rider's feet and the pedals, enabling the strength applied by the rider's legs to be effectively transmitted to said pedals.

In order to achieve the optimal force transmission effect, the design of said structure aims at tightly coupling a bicycle cleat of a racing bicycle pedal to a bicycle shoe sole. With reference to FIGS. 10 and 11, a pedal (1) has the front end thereof set a front clamping member (10) and has the rear end thereof set a rear clamping member (11). When a bicycle cleat (12) is coupled to said pedal (1), the front end of the cleat (12) is gripped underneath the front clamping member (10) and fixed by pressed force, the rear end of the cleat (12) is gripped underneath the rear clamping member (11) under pressure; therefore, the combination of the front and the rear ends of the invention is able to effectively achieve the ideal result of coupling a cleat to said pedal.

Nevertheless, said method may achieve the ideal result, a rider is unable to move his/her foot/leg joints resulting in uncomfortable riding; said structure for the racing purpose merely focuses on the design of tightly coupling the cleat (12) to the pedal (1), in order to effectively achieve the optimal force transmission effect. Consequently, the angels of moving the cleat (12) are within limits after coupling the cleat (12) and the pedal (1) together. However, the heel portion of the pedal comprises a spring that is used to change the tightness of the cleat from the pedal by adjusting an attachment bolt coupled to the spring, thereby enabling the cleat (12) to pivotally rotate at specific angels of 0°, 3°, 6°, 9° horizontally following a foot movement. Nevertheless, it is easy for a rider to make the cleat (12) slide out when s/he tries to loose the spring during the bicycle riding; even if the cleat (12) does not slide out, the force at the heel portion easily enables the angles between the cleat (12) and the pedal (1) to loosen, so as to lose the leg strength leads to the force on the pedals.

In recent years, more and more people concern about leisure time spending beyond their working hours, a lot of bicycle riders enjoy their riding and choose their bicycle riding shoes with fasteners disposed on the shoe soles to couple to the bicycle pedals during riding. Nevertheless, the bicycle riding is not for the racing purpose only, many bicycle riders enjoy their long time riding. Therefore, those bicycle riders who enjoy long time riding need to flexibly move their foot/leg joints to relax their leg tightness and enjoy more comfortable riding. However, existing bicycle structures can hardly meet such a requirement to be a main issue to be solved.

To solve the afore-mentioned problems, the “pedal structure without front clamping members” of the invention is disclosed herein with more practical application and effect for use.

### SUMMARY OF THE INVENTION

The main objective of the invention aims at providing a pedal structure without front clamping members that enables a rider to properly move their foot/leg joints during bicycle riding, so as to loosen the tightness on their legs and enjoy more comfortable riding. The bicycle pedals has a pedal shaft pierced into one lateral sides thereof each and a rear clamping member is disposed on a protruding portion of the rear ends thereof, in addition, the front end of the pedal has a circle portion arranged thereof, a stop fringe is disposed on the inner side of the circle portion;

First of all, in order to couple the cleat to the pedal, the front end of the cleat is put on the circle portion of the pedal and is pressed down by leg force, thereby the second half of the fastener is pressed under the rear clamping member on the second half of the pedal, so as to position the rear clamping member with a platform on the rear end of the fastener thereon and enable the front end of the fastener to swivel upwards owing to the leverage mechanism; consequently, the edge of a joint portion on the front end of the fastener is fixed against the position corresponding to a stop fringe on the pedal.

The invention enables only the front end of the cleat and the circle portion of the pedal to against each other for positioning, so that the cleat and a rider's foot/leg joints are able to horizontally swivel as appropriate or move up and downs at certain narrow angels during his/her bicycle riding. Therefore, the invention possesses the characteristics of enabling a rider to release the tightness on legs and enjoy more comfortable riding without losing the leg strength leads to the force on bicycle pedals, in addition, enabling the cleat to be easily come off a bicycle pedal.

### BRIEF DESCRIPTION OF THE DRAWINGS

FIG. 1 is a three-dimensioned view showing the appearance of the invention;

FIG. 2A is an outside view (I) showing the structure of a bicycle cleat of the invention;

FIG. 2B is an outside view (II) showing the structure of a bicycle cleat of the invention;

FIG. 3 is a three-dimensioned view showing the assembly of both structures as shown in FIGS. 1 and 2 according to the invention;

FIG. 4A is a side view of the invention;

FIG. 4B is a cutaway view showing the assembly application of the invention;

FIG. 5 is a plane view showing the assembly of this invention;

FIG. 6 is a perspective view (I) showing a state allowing wider moving angels according to this invention;

FIG. 7 is a perspective view (II) showing a state allowing wider moving angels according to this invention;

FIG. 8 is another perspective view (III) showing a state allowing wider moving angels according to this invention;

FIG. 9 is a structural view showing another embodiment of this invention;

FIG. 10 is a structural view showing a conventional bicycle pedal; and

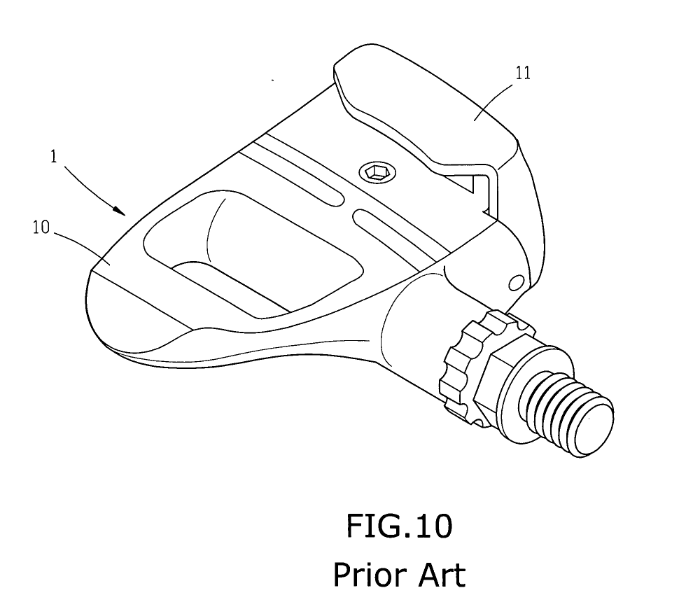

FIG. 11 is a perspective view showing a combination of pedals and cleats of a conventional bicycle.

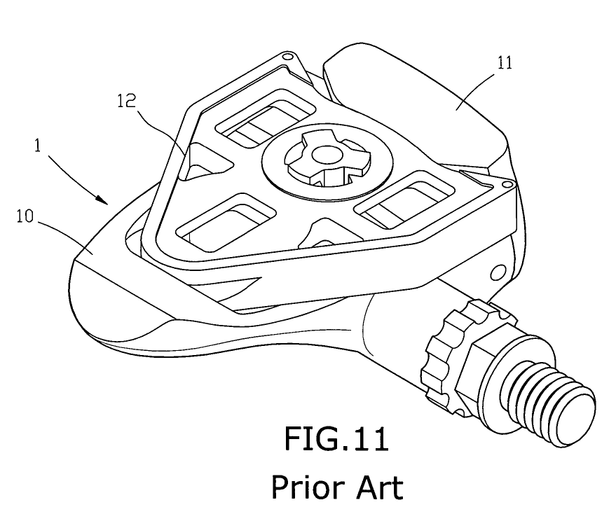

### DETAILED DESCRIPTION OF THE PREFERRED EMBODIMENTS

Further aspects, objects, and desirable features of the invention will be better understood from the detailed description and drawings that follow in which various embodiments of the disclosed invention are illustrated by way of examples.

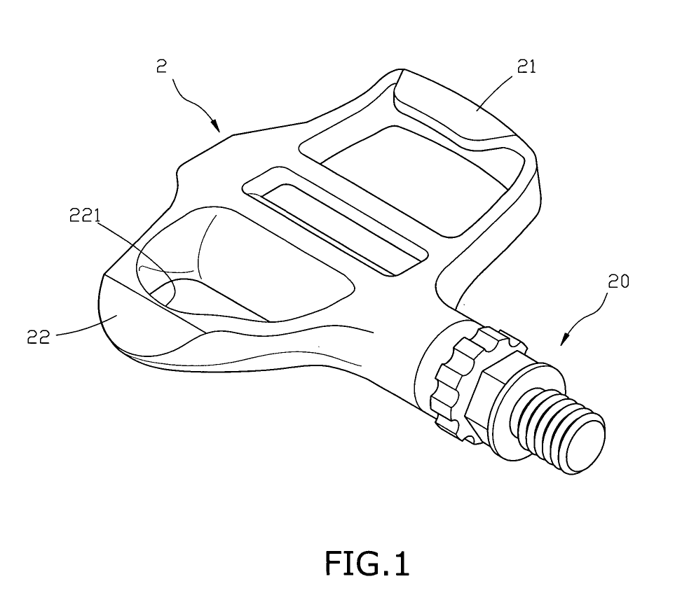

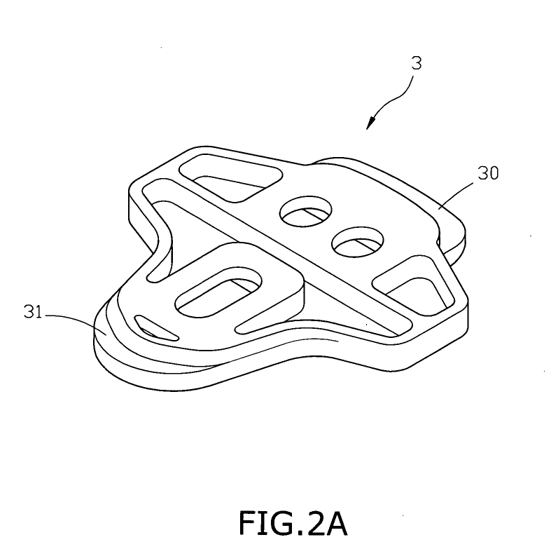

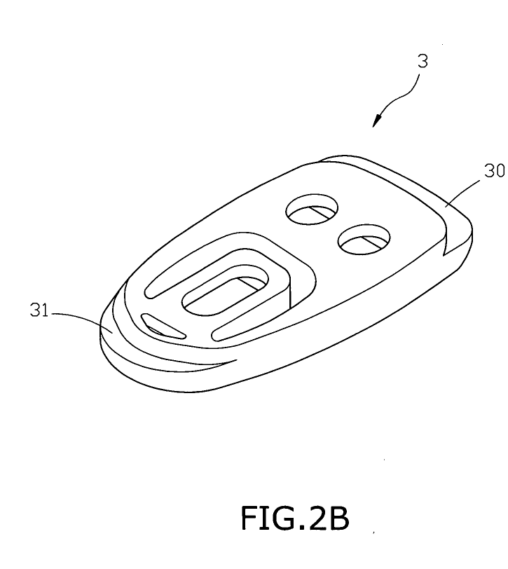

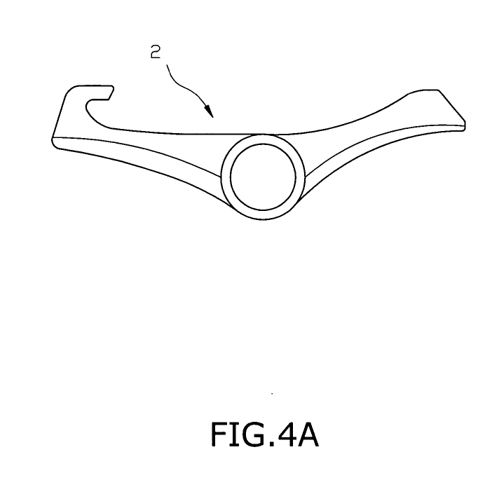

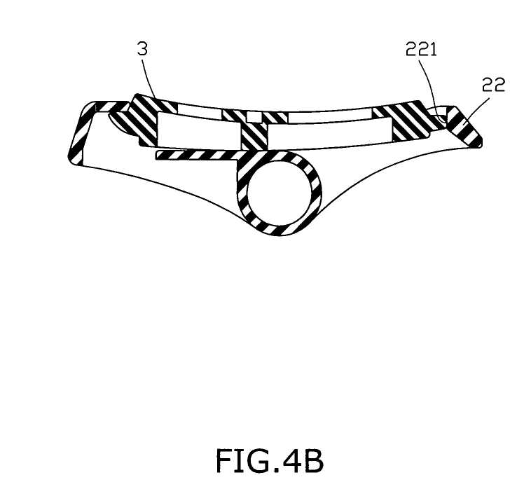

With reference to FIG. 1, the invention comprises a bicycle pedal (2) having a pedal shaft (20) piercing through one lateral side thereof and having a rear clamping member (21) disposted on a protruding portion on the rear ends thereof, in addition, the front end of the pedal has a circle portion of (22) arranged thereof and a stop fringe (221) is disposed on the inner side of the circle portion (22) (as shown in FIG. 4B). With reference to FIG. 2, a platform (30) is extendly disposed on the rear end of the cleat (3) and a joint portion (31) is disposed on the front end thereof.

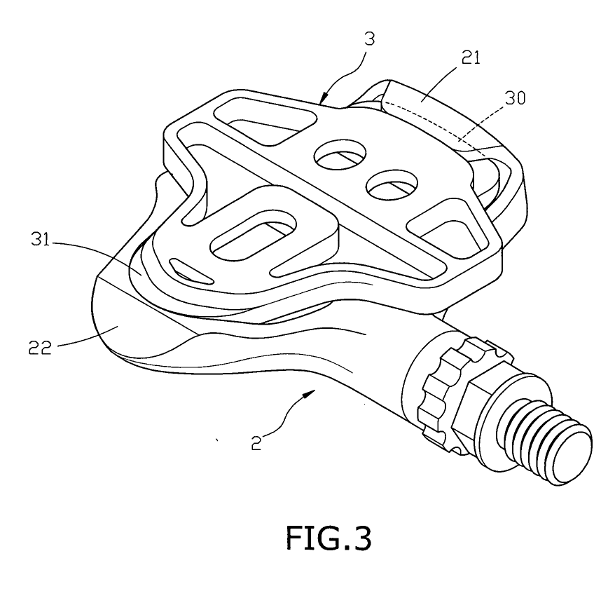

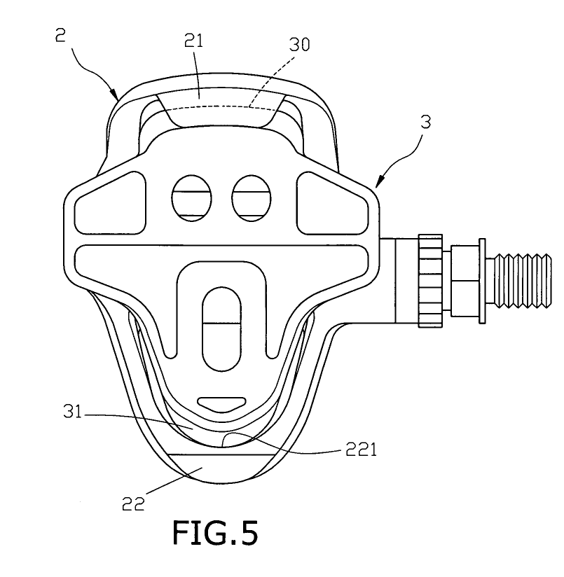

With reference to FIGS. 3, 4A, 4B and 5, in order to couple the cleat (3) to the pedal (2), the front end of the cleat (3) is put on the circle portion (22) of the pedal (2) and is pressed down by leg force, thereby the second half of the fastener is pressed under the rear clamping member (21) on the second half of the pedal (2), so as to enable the rear clamping member (21) to position and clamp the platform (30) by pressing force on the rear end of the fastener (3) and enable the joint portion (31) on the front end of the fastener to swivel upwards owing to the leverage mechanism, the edge of the joint portion (31) on the front end of the fastener is fixed against the position corresponding to a stop fringe (221) on the pedal (2).

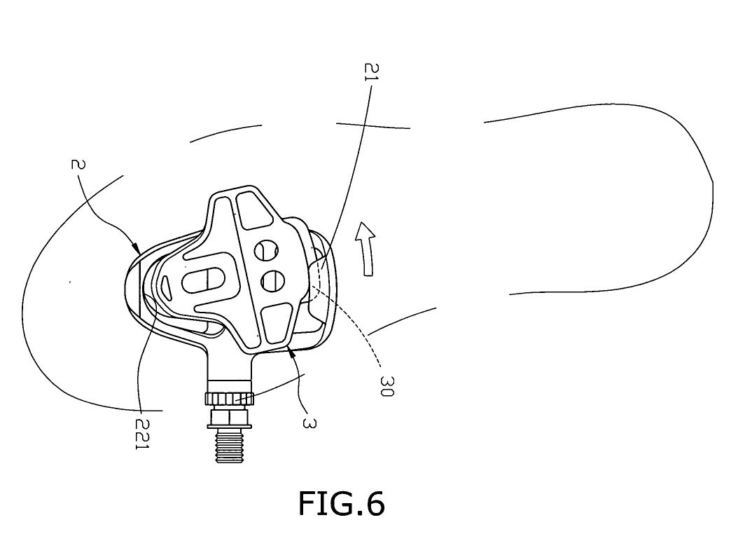

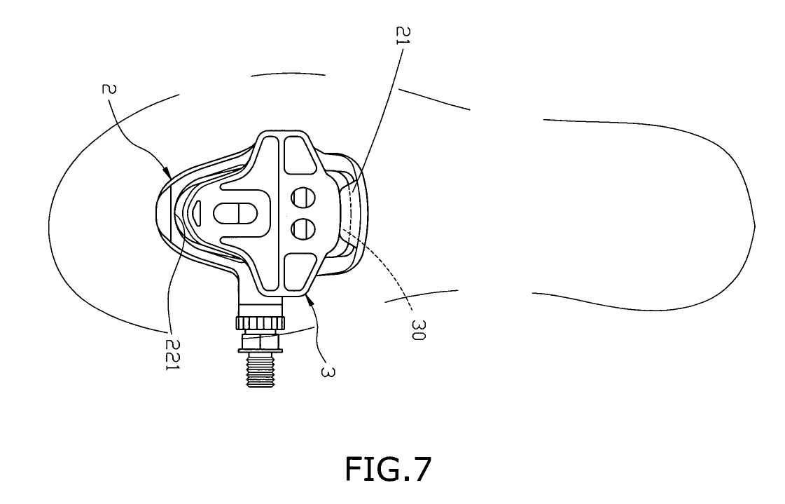

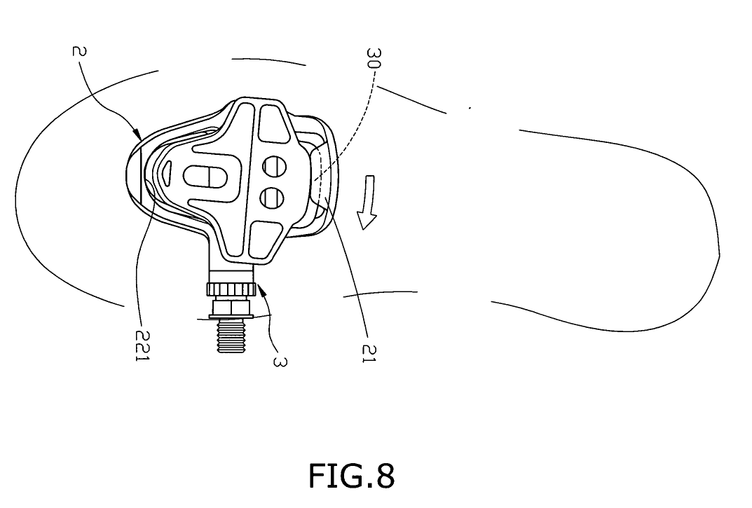

Consequently, the invention enables a rider's foot/leg joints to move at certain angels as appropriate during his/her bicycle riding, for the reason that the front end of the cleat (3) and the front end of the pedal (2) are horizontally clamped together, thereby enabling said clamped position that the joint portion (31) on the the front end of the cleat (3) against the circle portion (22) of the pedal (2) to be the origin point. Therefore, when a rider wants to stretch his/her legjoints during his/her bicycle riding, the end of the cleat (3) only allows the top thereof to be clasped by the rear clamping member (21) of the pedal (2), so that the cleat (3) and a rider's foot/leg joints are able to horizontally swivel as appropriate(as shown in FIGS. 6, 7 and 8) and move up and downs at certain narrow angels during his/her bicycle riding, allowing the rider's foot/leg joints to have proper stretching space and enabling the rider to release the tightness on legs and enjoy more comfortable riding; without the limitation of positioning front clamping members on bicycle pedals, the invention enables the cleat (3) to be come off said pedal without causing the problem of enabling the cleat to easily slipping from said pedal.

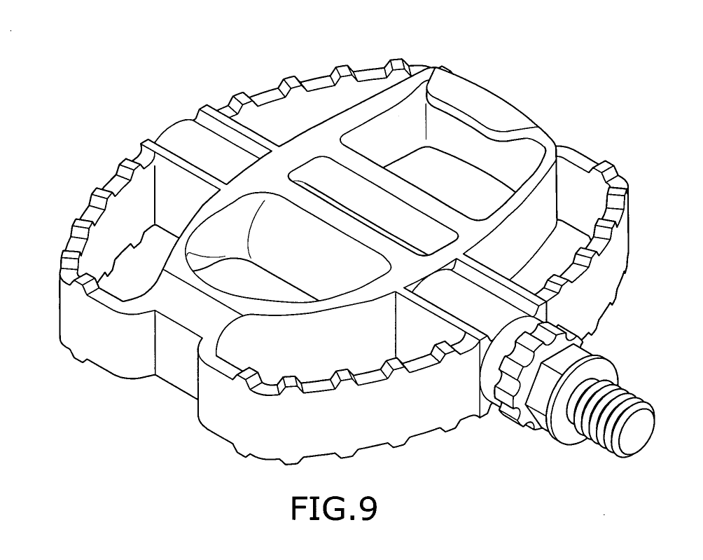

With reference to FIG. 9, the structure of the invention is able to be applied to all-purpose pedals.

To conclude the above description, the “pedal structure without front clamping members” of the invention comprises the originity and practicability to achieve better effectss.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claim is:

1. A pedal structure without front clamping members, comprising: a pedal having a pedal shaft piercing through one lateral side thereof and having a rear clamping member disposed on a protruding portion on the rear ends thereof, the characteristic of the invention lies in:
disposing a stop fringe on the inner side of a circle portion positioned on the front end of the pedal;
putting the front end of the cleat on the circle portion of the pedal, pressing the second half of fastener under the rear clamping member on the second half of the pedal; enabling the rear clamping member to position and clamp a platform by pressing force on the rear end of the fastener; enabling a joint portion on the front end of the fastener to swivel upwards owing to the leverage mechanism; fixing the edge of the joint portion on the front end of the fastener against the position corresponding to a stop fringe on the pedal;
allowing the joint portion on the front end of the cleat and the circle portion of the pedal to be positioned and against each other, so that the cleat and a rider's foot/leg joints are able to horizontally swivel as appropriate or move up and downs at certain narrow angels during his/her bicycle riding; enabling a rider to release the tightness on legs and enjoy more comfortable riding without losing the leg strength leads to the force on bicycle pedals, in addition, enabling the cleat to be easily come off a bicycle pedal.
